(19) United States
(12) Patent Application Publication
(10) Pub. No.: US 2005/0110793 A1
(43) Pub. Date: May 26, 2005

(54) Methods and systems for graphics processing in a medical imaging system

(76) Inventor: Erik N. Steen, Moss (NO)

Correspondence Address: Dean Small;Armstrong Teasdale LLP, Suite 2600, One Metropolitan Square, St. Louis, MO, 63102, US

(21) Appl. No.: 10/719,773

(22) Filed: Nov. 21, 2003

(51) Int. Cl. G06F 13/00; G06T 15/00

(52) U.S. Cl. 345/536

(57) ABSTRACT

Graphics processing circuitry includes a graphics processing unit, a system interface coupled to the graphics processing unit, and a graphics memory coupled to the graphics processing unit. The graphics memory holds an image data block, a vertex data block, and rendering plane definitions. The image data block stores image data entries for at least one ultrasound imaging beam and the vertex data block stores vertex entries that define rendering shapes. The graphics processing unit accesses the image data entries and vertex entries to render, from back to front or back to front using alpha compositing, a volume according to the rendering plane definitions.

### BACKGROUND OF THE INVENTION

1. Field of the Invention

This invention relates generally to medical imaging systems. More specifically, this invention relates to high speed graphics processing, for example, for rendering and displaying ultrasound image data on a display.

2. Related Art

Doctors and technicians commonly employ medical imaging systems to obtain, display, and study anatomical images for diagnostic purposes. In ultrasound imaging systems, for example, a doctor may obtain heart images in an attempt to learn whether the heart functions properly. In recent years, these imaging systems have become very powerful, and often include high density ultrasound probes capable of obtaining high resolution images of a region of interest.

It would be beneficial in many instances for a doctor, using such probes, to view a rapid or real-time image sequence of a three dimension region over a significant section of anatomy. However, preparing and displaying such images has typically been a time consuming and difficult task for the imaging system. In order to prepare and display the images, the imaging system must analyze a vast amount of complex data obtained during the examination, determine how to render the data in three dimensions, and convert that data into a form suitable for the attached display.

As a result, the imaging systems typically spent a relatively large percentage of time and processing power to render and display images. In a sophisticated imaging system, such processing power could instead be applied to many other tasks, for example, presenting a more user-friendly interface and responding more quickly to commands. Furthermore, the degree of time and processing power required to render and display the images limited the amount and sophistication of rendering and other display options that could be applied, while still maintaining a suitable frame rate.

Therefore, there is a need for systems and methods that address the difficulties set forth above and others previously experienced.

### BRIEF DESCRIPTION OF THE INVENTION

In one embodiment, graphics processing circuitry for a medical imaging system includes a graphics processing unit, a system interface coupled to the graphics processing unit, and a graphics memory coupled to the graphics processing unit. The graphics memory holds an image data block, a vertex data block, and rendering plane definitions. The image data block stores image data entries for at least one imaging beam and the vertex data block stores vertex entries that define rendering shapes. The graphics processing unit accesses the image data entries and vertex entries to render a volume according to the rendering plane definitions.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the marking systems and methods. In the figures, like reference numerals designate corresponding parts throughout the different views.

FIG. 1 illustrates an ultrasound imaging system that may employ the graphics processing method and systems explained below.

FIG. 2 shows a graphics processing circuitry that the ultrasound system in FIG. 1 uses to render and display images.

FIG. 3 shows an example of an array of beam data acquired by the imaging system shown in FIG. 1.

FIG. 4 shows the starting and ending points for four beams with data stored in the beam data array shown in FIG. 3.

FIG. 5 shows a triangle strip formed from individual triangles with vertices obtained from the array of beam data shown in FIG. 3.

FIG. 6 shows a three dimensional volume obtained by the imaging system shown in FIG. 1.

FIG. 7 shows the three dimensional volume of FIG. 6 with two triangles defined for each of three image planes to be rendered by the graphics circuitry shown in FIG. 2.

FIG. 8 shows the rendering applied to an image plane of the three dimensional volume shown in FIG. 7.

FIG. 9 shows the contents of the graphics memory for the graphics circuitry shown in FIG. 3.

FIG. 10 shows a more detailed view of the contents of the graphics memory for the graphics circuitry shown in FIG. 3.

FIG. 11 shows the steps taken by the graphics circuitry shown in FIG. 3 to render and display images.

### DETAILED DESCRIPTION OF THE INVENTION

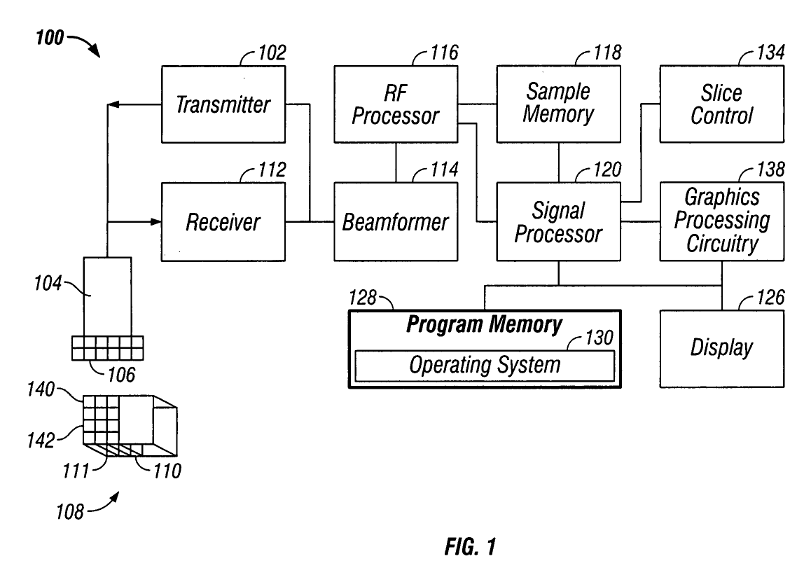

FIG. 1 illustrates a diagram of the functional blocks of an ultrasound system 100. The functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, and so forth). Similarly, the programs may be separate stand alone programs or routines in a single program, may be incorporated as functions in an operating system, may be subroutines or functions in an installed imaging software package, and so forth.

The ultrasound system 100 includes a transmitter 102 which drives image sensor, such as ultrasound probe 104. The ultrasound probe 104 includes an array of transducer elements 106 that emit pulsed ultrasonic signals into a region of interest 108 (e.g., a patient's chest). In some examinations, the probe 104 may be moved over the region of interest 108, or the beamformer 114 may steer ultrasound beams, in order to acquire image information over the scan planes 110, 111 across the region of interest 108. Each scan plane may be formed from multiple adjacent beams (two of which are labeled 140, 142).

The transducer array 106 may conform to one of many geometries, as examples, a 1D, 1.5D, 1.75D, or 2D probe. The probe 104 is one example of an image sensor that may be used to acquire imaging signals from the region of interest 108. Other examples of image sensors include solid state X-ray detectors, image intensifier tubes, and the like. Structures in the region of interest 108 (e.g., a heart, blood cells, muscular tissue, and the like) back-scatter the ultrasonic signals. The resultant echoes return to the transducer array 106.

In response, the transducer array 106 generates electrical signals that the receiver 112 receives and forwards to the beamformer 114. The beamformer 114 processes the signals for steering, focusing, amplification, and the like. The RF signal passes through the RF processor 116 or a complex demodulator (not shown) that demodulates the RF signal to form in-phase and quadrature (I/Q) data pairs representative of the echo signals, or multiple individual values obtained from amplitude detection circuitry. The RF or I/Q signal data may then be routed directly to the sample memory 118.

The ultrasound system 100 also includes a signal processor 120 to coordinate the activities of the ultrasound system 100, including uploading beam data and rendering parameters to the graphics processing circuitry 138 as explained in more detail below. The graphics processing circuitry 138 stores beam data, vertex data, and rendering parameters that it uses to render image frames and output the display signals that drive the display 126. The display 126 may be, as examples, a CRT or LCD monitor, hardcopy device, or the like.

The signal processor 120 executes instructions out of the program memory 128. The program memory 128 stores, as examples, an operating system 130 for the ultrasound system 100, user interface modules, system operating parameters, and the like. In general, the signal processor 120 performs selected processing operations on the acquired ultrasound information chosen from the configured ultrasound modalities present in the imaging system 100. The signal processor 120 may process in real-time acquired ultrasound information during a scanning session as the echo signals are received. Additionally or alternatively, the ultrasound information may be stored in the sample memory 118 during a scanning session and processed and displayed later after the examination is complete. In general, the ultrasound system 100 may acquire ultrasound image data at a selected frame rate (e.g., 5-50 2D or 3D images per second) and, by employing the graphics processing circuitry 138, coordinate display of derived 2D or 3D images at the same or different frame rate on the display 126.

The probe 104 may be used in conjunction with techniques including scanning with a 2D array and mechanical steering of 1-1.75D arrays. The beamformer 114 may steer the ultrasound beams to acquire image data over the entire region of interest 108. As will be explained in more detail below, the probe 104 may acquire image data for a full volume around the region of interest 108, and transfer that data to the graphics processing circuitry 138 for rendering.

When the probe 104 moves, or the beamformer 114 steers firings, along a linear or arcuate path, the probe 104 scans the region of interest 108. At each linear or arcuate position, the probe 104 fires an ultrasound beam into the region of interest 108 to obtain image data for a scan plane 110, 111. Adjacent scan planes may be acquired in order to cover a selected anatomical thickness. An operator may set the thickness by operating the control input 134.

More generally, the probe 104 obtains image components to reconstruct a three dimensional volume. Thus, as one example, the probe 104 may obtain image components in the form of regular sector scan planes that are assembled to form the volume. However, the probe 104 and graphics processing circuitry 138 are not limited to sector scan planes. In general, the probe 104 and graphics processing circuitry 138 may instead obtain and operate on a wide range of image components, including scan planes of different shape, curved surfaces, and the like, to render a complete volume. Thus, although the explanation below refers, for purposes of illustration, to “scan planes”, the methods and systems are more generally applicable to image components that may be assembled to render a three dimensional volume. Further, the graphics processing circuitry 138 may cut away data from one side of a plane. Several such cut away planes enables a user to cut away unwanted volume data.

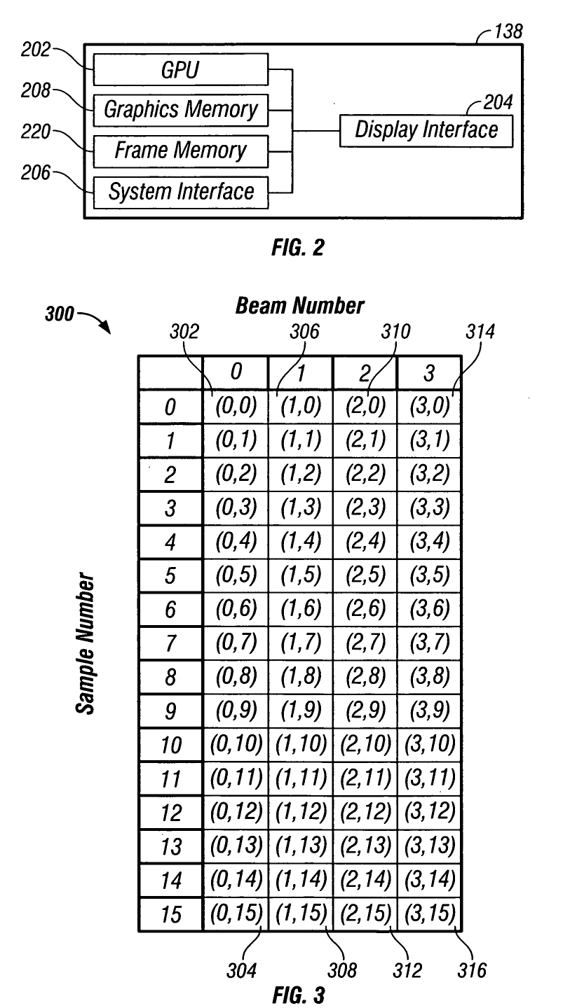

With regard to FIG. 2, that figure depicts the graphics processing circuitry 138. The graphics processing circuitry 138 includes a graphics processing unit (GPU) 202, a display interface 204, and a system interface 206. The circuitry 138 also includes a graphics memory 208. The graphics processing circuitry 138 may be located on a dedicated processing board, for example, or the GPU 202 and graphics memory 208 may be integrated into the same system board as the signal processor 120, or other processing circuitry.

The GPU 202 may be, for example, an NVidia GeForce3™ GPU, or another commercially available graphics processor that supports volume textures. The display interface 206 may be an Red, Green, Blue CRT display driver, or a digital flat panel monitor driver, as examples. The display interface 206 takes image frames prepared by the GPU 202 that are stored in the frame memory 220 and generates the display control signals to display the image frames on a selected display. The system interface 206 provides a mechanism for communicating with the remainder of the image processing system 100. To that end, the system interface 206 may be implemented as a Peripheral Component Interconnect (PCI) interface, Accelerated Graphics Port (AGP) interface, or the like.

With regard next to FIG. 3, that figure shows an example of an array 300 of beam data acquired by the imaging system 100. Although the discussion below may make reference, for explanatory purposes, to parameters including a particular number of scan planes, beams per scan plane, and samples per beam, the graphics processing circuitry 138 is not limited to any given number of those parameters. Rather, the methods and systems discussed are generally applicable to images formed from a wide range in the number of scan planes, number of beams per plane, and number of samples per beam, or, more generally, the number of ultrasound beams per volume.

The array 300 includes beam data for four beams numbered zero (0) through three (3). Each beam includes 16 samples along it's length, labeled 0 through 15. Each beam has a start point (e.g., the first sample for that beam) and an end point (e.g., a last sample for that beam). The array 300 includes a beam 0 start point 302 (0,0) and a beam 0 end point 304 (0,15), as well as a beam 1 start point 306 (1,0) and a beam 1 end point 308 (1,15). The array 300 also includes a beam 2 start point 310 (2,0) and a beam 2 end point 312 (2,15), as well as a beam 3 start point 314 (3,0) and a beam 3 end point 316 (3,15).

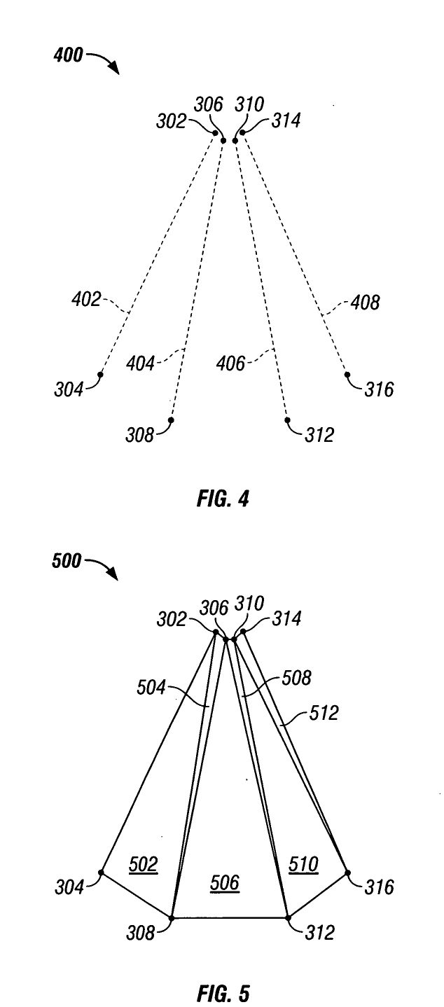

FIG. 4 shows a sector diagram 400 with four beams 402, 404, 406, and 408 for which data is stored in the array 300. Beam zero 402 is shown with its start point 302 and end point 304 and beam one 404 is shown with its start point 306 and end point 308. Similarly, beam two 406 is shown with its start point 310 and end point 312, and beam three 408 is shown with its start point 314 and end point 316. The beams 402-408 form one scan plane (in the shape of a sector). In general, many more beams and many more samples per beam would be used for a scan plane. For example, the ultrasound system 100 may used 128 beams per scan plane and 256 samples per beam.

As will be described in more detail below, the GPU 202 may render and display ultrasound images by setting up the graphics memory 208 to define triangles (or other shapes that the GPU 202 can process) that form the image. FIGS. 5-8 present and explain how triangles may be employed in this regard.

FIG. 5 shows a triangle strip 500 formed from individual triangles 502, 504, 506, 508, 510, and 512. The triangles 502-512 are specified by vertices obtained from the beam data array 300 shown in FIG. 3. The triangles and vertices are summarized below in Table 1.

TABLE 1

| Triangle | Vertex 1 | Vertex 2 | Vertex 3 |
|---|---|---|---|
| 502 | 302 | 304 | 308 |
| | (beam 0 start point) | (beam 0 end point) | (beam 1 end point) |
| 504 | 302 | 308 | 306 |
| | (beam 0 start point) | (beam 1 start point) | (beam 1 start point) |
| 506 | 306 | 308 | 312 |
| | (beam 1 start point) | (beam 1 end point) | (beam 2 end point) |
| 508 | 306 | 312 | 310 |
| | (beam 1 start point) | (beam 2 end point) | (beam 2 start point) |
| 510 | 310 | 312 | 316 |
| | (beam 2 start point) | (beam 2 end point) | (beam 3 end point) |
| 512 | 310 | 316 | 314 |
| | (beam 2 start point) | (beam 3 end point) | (beam 3 start point) |

Note that the sequence of triangles 502-512 in the triangle strip 500 give the appearance of an arc-shaped sector image for a scan plane. In general, a larger number of triangles (e.g., 512) may be employed to form a sector image that more closely conforms to any desired sector shape. The number of triangles employed is not limited by the number of ultrasound beams. Rather, a given beam may be considered a sector in its own right, and divided and rendered using many triangles. Since vertex coordinates in general may be stored as floating point numbers, it is possible to create these triangles by defining several start and end vertices per beam with sub-beam precision. The graphics hardware may then automatically interpolate between beams that are actually obtained by the beamformer 114.

While the graphics processing circuitry 138 may be employed to render and display a single scan plane composed of multiple triangles, the graphics processing circuitry 138 may also be employed to render a complete volume using the image data obtained by the probe 104 (e.g., multiple scan planes). When for example, the scan planes are rendered from back to front (e.g., in order of depth, or distance from a specified viewplane), the graphics processing circuitry 138 generates a three dimensional volume image.

In one embodiment, the graphics processing circuitry 138 may employ alpha-blending (sometimes referred to as alpha compositing) during the volume rendering process. To that end, the signal processor 120 or the graphics processing circuitry 138 associates transparency data with each pixel in each scan plane. The transparency data provides information to the graphics processing circuitry 138 concerning how a pixel with a particular color should be merged with another pixel when the two pixels are overlapped. Thus, as scan planes are rendered from back to front, the transparency information in pairs of pixels will help determine the pixel that results as each new plane is overlaid on the previous result.

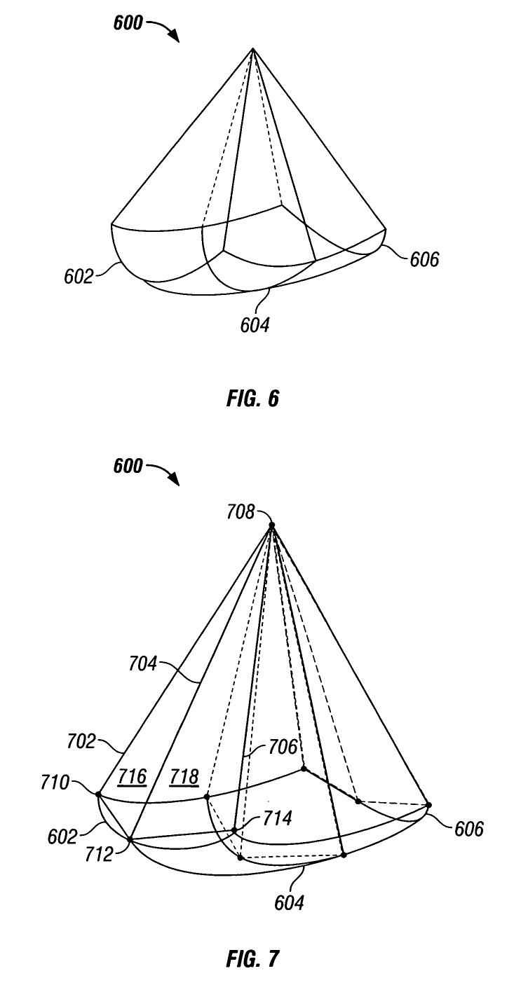

For example, FIG. 6 shows a three dimensional volume 600 obtained by the imaging system 100 shown in FIG. 1. The volume 600 includes multiple scan planes, three of which are designated 602, 604, and 606. The scan planes, including the three scan planes 602-606, provide ultrasound image data over the volume 600.

Each scan plane 602-606 is formed from multiple ultrasound beams. Each ultrasound beam will be associated with many sampling points taken along the beam. The sampling points for each beam (e.g., the start and end points) may be employed to define triangles for the GPU 202 to render.

Thus, for example, with regard to FIG. 7, that Figure shows the three dimensional volume 600 with two triangles defined for each of three scan planes. Included in FIG. 7 are the first scan plane 602, second scan plane 604, and third scan plane 606. The GPU 202 will render the scan planes from back to front (606, 604, then 602) using alpha blending, for each triangle used to form each plane. For example, the GPU 202 may first render the scan plane 606, then overlay the scan plan 604 on top. An intermediate result is produced, that includes image pixels obtained using alpha blending between the scan planes 606 and 604. The GPU 202 continues by overlaying the scan plane 602 on top of the intermediate result. The final result is formed from alpha blending between the intermediate result, and the scan plane 602. In practice, many more triangles and scan planes may be used.

The first scan plane 602 includes three ultrasound beams 702, 704, and 706. The beam 702 includes a start point 708 and an end point 710. The beam 704 includes the start point 708 and the end point 712. The beam 706 includes the start point 708 and the end point 714.

The first scan plane 602 will be approximated by two triangles 716 and 718. The adjacent triangles 716 and 718 share two common vertices. The two triangles 716 and 718 spread out in a triangle fan from the apex vertex. However, as illustrated above with regard to FIG. 5, triangles need not spread out from a common vertex. Thus, more generally, the triangles employed to render an image plane form a triangle strip rather than a triangle fan. The vertices of the two triangles 716 and 718 are set forth below in Table 2.

TABLE 2

| Triangle | Vertex 1 | Vertex 2 | Vertex 3 |
|---|---|---|---|
| 716 | 708 | 710 | 712 |
| | (beam 702-706 | (beam 702 end | (beam 704 end |
| | start point) | point) | point) |
| 718 | 708 | 712 | 714 |
| | (beam 702-706 | (beam 704 end | (beam 706 end |
| | start point) | point) | point) |

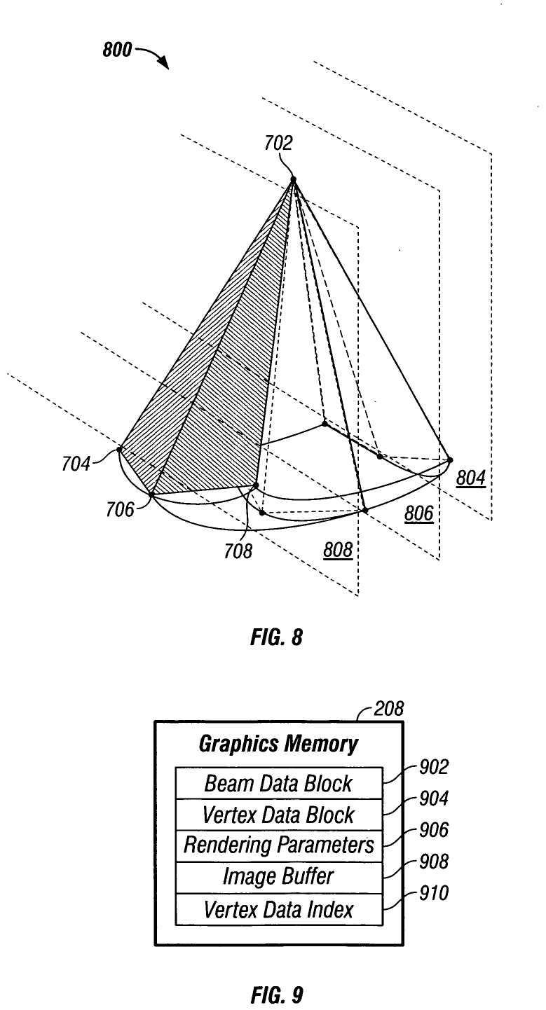

Turning briefly to FIG. 8, that Figure shows a rendered volume 800 in which the triangles 716 and 718 have been rendered to produce the rendered scan plane 802. The rendered scan plane 802 includes a texture that results from back to front blending of all of the scan planes in accordance with the rendering planes 804 (farthest back), 806, 808 (closest forward). The scan planes 804-808 provide the GPU 202 with a rendering sequence as discussed in more detail below. The scan planes may be rendered, for example, according to rendering parameters also stored in the graphics memory 208.

FIG. 9 shows exemplary parameters that are stored in the graphics memory 208. The signal processor 120 may, for example, store the parameters in the graphics memory 208 by transferring data over the system interface 206. In one embodiment, the graphics memory 208 stores beam data in the beam data block (image data block) 902 (which may be regarded as texture memory), vertex data in the vertex data block 904, and rendering parameters 906.

As the GPU 202 renders a volume, the GPU 202 blends each plane or image component with the content held by the frame buffer 908. Optionally, the graphics memory 208 may also include a vertex data index 910.

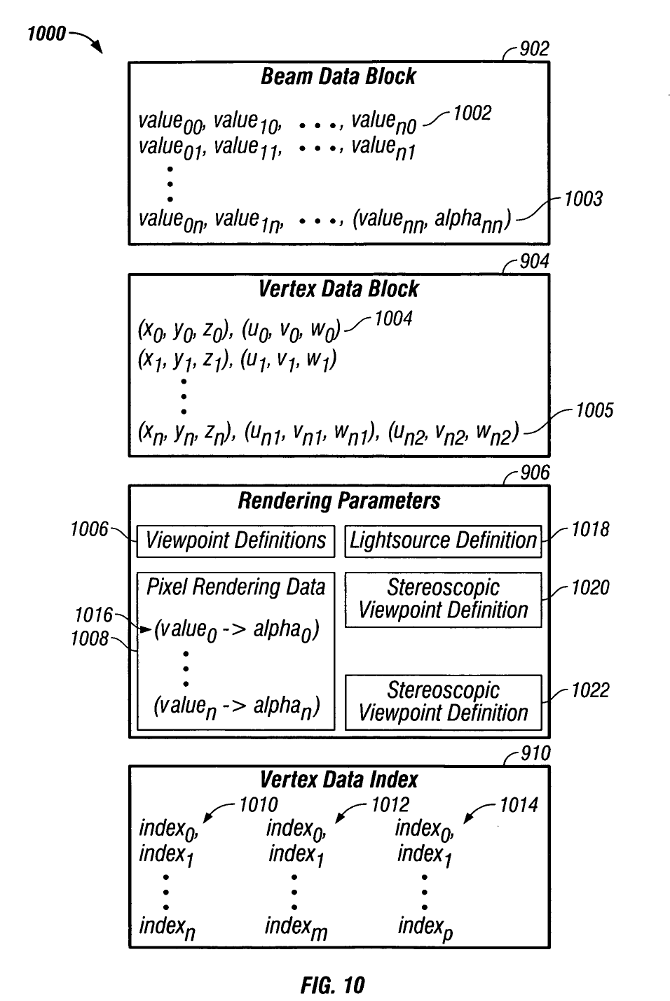

A more detailed view of the parameters 1000 in the graphics memory 208 is shown in FIG. 10. The beam data block 902 stores image data entries 1002 obtained for each ultrasound beam. The beam data block 902 may assume the role of a texture memory, as noted below. In general, the beamformer 114 will provide data points for each beam in polar coordinates (r, theta, sample point value). The beam data block 902 may then store the sample values for each beam or other image component. As an example, the image data entry “value₂₃” represents the sample point value for sample 2 of beam 3. The sample point value may represent, as examples, a multi-bit (e.g., 8-bit) color flow, Doppler intensity, tissue, or a color value (e.g., a 24-bit RGB color value) for that data point. Optionally, each image data entry may also include a multi-bit (e.g., 8-bit) transparency or alpha parameter for the alpha blending operation. One example is shown as the image data entry 1003.

The GPU 202 employs the data in the beam data block 902 as texture memory. In other words, when the GPU 202 renders the triangles that form the image planes, the GPU 202 turns to the data in the beam data block 902 for texture information. As a result, the triangles are rendered with ultrasound imaging data as the applied texture, and the resultant images therefore show the structure captured by the imaging system 100.

Because it is a dedicated hardware graphics processor, the GPU 202 generates image frames at very high speed. The imaging system 100 may thereby provide very fast image presentation time to doctors and technicians working with the imaging system 100. Furthermore, with the GPU 202 performing the processing intensive graphics operations, the remaining processing power in the imaging system 100 is free to work on other tasks, including interacting with and responding to the doctors and technicians operating the imaging system 100.

The vertex data block 904 includes vertex entries 1004 that define rendering shapes (e.g., triangles, or other geometric shapes that the GPU 202 can manipulate). The vertex data entries 1004, for example, may specify triangle vertices for the GPU 202. Each vertex entry 1004 may include a spatial location for the vertex and a texture location for the vertex. The spatial location may be an x, y, z coordinate triple, to identify the location of the vertex in space. The spatial location may be provided by the beamformer 114 that controls and steers the beams.

The texture location may be a pointer into the beam data block 902 to specify the data value for that vertex. In one implementation, the texture location is expressed as a texture triple u, v, w that indexes the beam data block 902. More particularly, when the sample point values are conceptually organized along a u-axis, a v-axis, and a w-axis, the texture triple u, v, w specifies a point in the beam data block 902 from which the GPU 202 retrieves a sample point value for the vertex in question. The texture triples are stored, in general, as floating point numbers. Thus, sample points may be specified with sub-sample precision. When the selected GPU 202 supports tri-linear interpolation, the GPU 202 may then map interpolated texture values to the frame buffer 908 rather than selecting the closest sample from an ultrasound beam. As a result, the GPU 202 may generate smooth images even when the number of ultrasound beams in a 3D dataset is limited.

In one implementation, the order of the vertices in the vertex data block 904 will specify a series of triangles in a geometric rendering shape, for example a triangle strip, triangle list, or triangle fan. To that end, the processor 120 may store the vertices in the vertex data block 904 such that each scan plane may be approximated by a series of triangles. Generally, a triangle strip is a set of triangles for which each triangle shares two vertices with a preceding triangle. The first three vertices define a triangle and then each additional vertex defines another triangle by using the two preceding vertices.

For the example shown above in FIG. 5, the order of vertices in the vertex data block 904 may be: 304, 302, 308, 306, 312, 310, 316, and 314. Vertices 304, 302, 308 specify triangle 502; vertices 302, 308, and 306 specify triangle 504; vertices 308, 306, and 312 specify triangle 506; vertices 306, 312, and 310 specify triangle 508; vertices 312, 310, and 316 specify triangle 510; and vertices 312, 316, and 314 specify triangle 512.

The GPU 202 retrieves the vertices from the vertex data block 904. As the GPU 202 renders the triangles, the GPU 202 applies texture to the triangles specified by the texture triples. In doing so, the GPU 202 retrieves sample point values from the beam data block 902 for the pixels that constitute each rendered triangle. Thus, while the vertex entries specify the boundary sample point values at the three vertices of a given triangle, the GPU 202 employs the data taken along each beam (away from the vertices) to render the area inside the triangle.

With regard to the rendering parameters 906, those parameters include a viewpoint definition 1006 and pixel rendering data 1008. The viewpoint definition 1006 specifies the rendering viewpoint for the GPU 202 and may be given by a point on an arbitrary plane, and a view plane normal to specify a viewing direction. Multiple viewpoint definitions (rendering plain definitions) 1006 may be provided so that the GPU 202 can render and display image frames drawn from multiple viewpoints, as an aid in helping a doctor or technician locate or clearly view features of interest.

Additionally, the vertex data index 910 may specify three or more sets of rendering geometries that the GPU 202 may employ to render the image components from back to front from any desired direction. Each set of rendering geometries defines, as examples, one or more rendering planes at a given depth or curved surfaces for the GPU 202. Each rendering plane may be specified using a vertex list interpreted as a triangle strip. The plane (or curved surface) along which the triangle strip lies defines the rendering plane or curved surface.

The rendering planes may be specified at any given angle with regard to the image components obtained. As examples, a first set of rendering geometries may be as described above with regard to sector planes (e.g., along each beam). A second set of rendering geometries may then be defined using rendering planes that are orthogonal to the first set of rendering planes (e.g., cutting across each beam at pre-selected sample points along the beams). A third set of rendering geometries may be employed when viewing the image components from a direction approximately parallel to the sector planes. In that instance, a third set of rendering geometries may then be defined in which each rendering plane has a different fixed distance to the center of a sector (with a viewpoint above the center of a sector).

With regard next to the pixel rendering data 1008, that data provides, for example, a lookup table 1016 that maps between beam data values and color or transparency values. As a result, the GPU 202 may correspondingly apply that color or transparency to a pixel rendered using a particular beam data value. Thus, for example, increasingly dark values may be given transparency levels that makes the GPU 202 render them increasingly transparent, while increasingly bright values may be given transparency levels that makes the GPU 202 render them increasingly opaque. As noted above, the GPU 202 employs the transparency values when performing alpha blending during rendering.

In another implementation, the graphics memory 208 may also include a vertex data index 910. The vertex data index 910 includes one or more vertex index sets. In the example shown in FIG. 10, the vertex data index 910 includes three vertex index sets 1010, 1012, and 1014.

Each vertex index set includes one or more pointers into the vertex data block 904. Each pointer may be, for example, an integer value specifying one of the vertices in the vertex data block 904. Each vertex index set thus specifies. (in the same manner as explained above with regard to FIG. 5) a series of triangles that may form a triangle strip. Furthermore, because the triangles in the triangle strip define, generally, a curved surface or a plane, each vertex index 1010-1014 may also be considered to define a curved surface or a plane. Thus, rather than repeating all of the vertex data every time in a different order for each new plane, the graphics circuitry 138 may instead save substantial memory by adding a new vertex index set that refers to a common set of vertex data in the vertex data block 904, and that defines a new plane or curved surface (e.g., to be employed as the rendering geometries explained above).

Note that the GPU 202 may be instructed to mix two or more sets of beam data together at any given point. For instance, one dataset in the beam data block 902 may be B-mode (tissue) sample point values, while a second dataset in the beam data block 902 may be colorflow sample point values. One or more of the vertex entries may then specify two or more texture coordinates to be mixed. As an example, the vertex entry 1005 specifies two different texture coordinates (u, v, w) from which the GPU 202 will retrieve texture data when rendering that particular vertex.

In this regard, one of the datasets in the beam data block 902 may store local image gradients. The GPU 202 may then perform hardware gradient shading as part of the rendering process. In certain images, gradient shading may improve the visual appearance of tissue boundaries. One or more lightsource definitions 1018 may therefore be provided so that the GPU 202 may determine local light reflections according to the local gradients. The lightsource definitions 1018 may include, as examples, spatial (e.g., x, y, z) positions for the light sources, as well as lightsource characteristics including brightness or luminosity, emission spectrum, and so forth.

Furthermore, the datasets in the beam data block 902, in conjunction with a dataset in the vertex data block 904 (or vertex data index 910) may define other graphics objects or image components. For example, the beam data block 902 and vertex data block 904 may store triangle strips that define an anatomical model (e.g., a heart ventricle). The anatomical model may then be rendered with the ultrasound image data to provide a view that shows the model along with the actual image data acquired. Such a view may help a doctor or technician locate features of interest, evaluate the scanning parameters employed when obtaining the image data, and so forth.

The graphics processing circuitry 138 may also be employed in stereoscopic displays. To that end, the signal processor 120 may command the GPU 202 to render a volume from a first viewing direction, and then render a volume from a slightly different viewing direction. The two renderings may then be displayed on the display 126. When viewed through stereoscopic or three dimensional viewing glasses, the stereoscopic display yields a very realistic presentation of the rendered volume. The viewing directions may be specified by the stereoscopic viewpoint definitions, two of which are labeled 1020 and 1022 in FIG. 10.

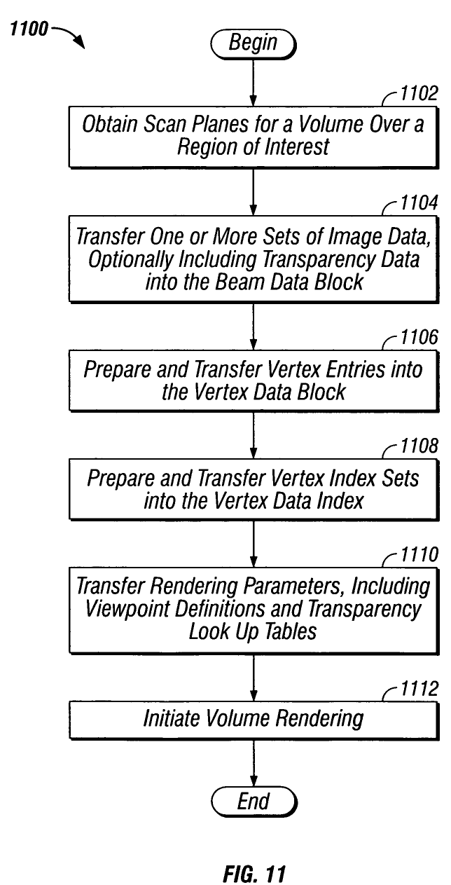

With regard next to FIG. 11, that Figure summarizes the steps 1100 taken by the imaging system 100 and graphics processing circuitry 138 to render a volume. The imaging system 100 obtains image components (e.g., scan planes) for a volume over a region of interest 108 (Step 1102). The signal processor 120, for example, then transfers one or more datasets of image data into the beam data block 902 (Step 1104). As noted above, the image data may optionally include transparency information, and multiple datasets may be provided that result from multiple types of imaging modes (e.g., colorflow and Doppler).

The signal processor 120 then prepares the vertex entries that define the triangles used to render an image component. For example, the vertex entries may specify triangle lists that define planes, curved surfaces, anatomical models, and the like. The signal processor 120 transfers the vertex entries to the vertex data block 904 (Step 1106). Similarly, the signal processor 120 prepares and transfers the vertex index sets described above into the vertex data index 910 (Step 1108).

In addition, the signal processor 120 may transfer the rendering parameters 906 into the graphics memory 208 (Step 1110). The rendering parameters include, as examples, viewpoint definitions, transparency lookup tables, light source definitions, stereoscopic viewpoints, and other pixel rendering information. Once the data and parameters have been transferred, the signal processor 120 may then initiate rendering of the three dimensional volume (Step 1112.) To that end, for example, the signal processor 120 may send a rendering command to the GPU 202.

While various embodiments of the invention have been described, it will be apparent to those of ordinary skill in the art that many more embodiments and implementations are possible that are within the scope of this invention.

1. Graphics processing circuitry for a medical ultrasound system, the graphics processing circuitry comprising:
a graphics processing unit;
a system interface coupled to the graphics processing unit; and
a graphics memory coupled to the graphics processing unit, the graphics memory comprising:
an image data block storing image data entries for at least one ultrasound beam,
a vertex data block storing vertex entries that define rendering shapes; and
rendering plane definitions,
where the graphics processing unit accesses the image data entries and vertex entries to render a volume according to the rendering plane definitions with blending parameters for selected image data entries and where the graphics processing unit renders the volume using alpha blending in accordance with the blending parameters.

2. The graphics processing circuitry of claim 1, where the graphics memory further comprises the graphics processing unit rendering the volume from back to front.

3. The graphics processing circuitry of claim 2, where the blending parameters are stored in the image data block.

4. The graphics processing circuitry of claim 2, where the blending parameters are stored in a look up table that maps sample values to blending parameters.

5. The graphics processing circuitry of claim 2, where the blending parameters are transparency values.

6. The graphics processing circuitry of claim 2, where the image data block stores a first dataset of image data entries for a plurality of ultrasound beams of a first type, and a second dataset of image data entries for a plurality of ultrasound beams of a second type, and wherein at least one of the vertex entries specifies a vertex spatial position, a texture pointer into the first data set, and a texture pointer into the second dataset.

7. The graphics processing circuitry of claim 6, where at least one of the first type and second type is colorflow.

8. The graphics processing circuitry of claim 6, where at least one of the first type and second type is B-mode.

9. The graphics processing circuitry of claim 6, where at least one of the first and second types is local image gradients.

10. The graphics processing circuitry of claim 9, further comprising a light source definition stored in the graphics memory.

11. The graphics processing circuitry of claim 1, where the vertex data block has a first set of vertex entries that define the rendering plane definitions and a second set of vertex entries specifies an anatomical model where the graphics processing unit accesses image data entries and the first set of vertex entries to render a volume according to the rendering plane definitions with blending parameters for the selected image data entries and the second set of vertex entries to render the anatomical model.

12. The graphics processing circuitry of claim 11, where the anatomical model is a pre-generate model of anatomical structure present in the volume to be rendered.

13. The graphics processing circuitry of claim 1, where the rendering shapes are triangles.

14. The graphics processing circuitry of claim 1, where the rendering shapes are triangles and where the vertex entries define at least one triangle strip.

15. The graphics processing circuitry of claim 1, where the graphics processing unit accesses the image data entries and vertex entries to render a volume absent an at least one cut away plane.

16. A medical ultrasound imaging system comprising:
an image sensor for obtaining image data from a volume of a region of interest;
a first memory;
a signal processor coupled to the image sensor and the first memory for receiving the image data and storing the image data in the first memory;
graphics processing circuitry comprising:
a graphics processing unit; and
a graphics memory coupled to the graphics processing unit,
where the signal processor stores image data entries for at least one ultrasound beam in a data block in the graphics memory, stores vertex entries that define blending shapes in a vertex data block in the graphics memory, and initiates rendering of the volume according to a plurality of rendering planes.

17. The medical ultrasound imaging system of claim 16, where the graphics processing unit blends the volume according to the rendering planes from back to front.

18. The medical ultrasound imaging system of claim 17, where the graphics processing unit blends the volume using alpha-blending.

19. The medical ultrasound imaging system of claim 16, where the signal processor stores, in the image data block, a first dataset of image data entries for a plurality of ultrasound beams of a first type, and a second dataset of image data entries for a plurality of ultrasound beams of a second type, and wherein at least one of the vertex entries specifies a vertex spatial position, a texture pointer into the first data set, and a texture pointer into the second dataset.

20. The medical ultrasound imaging system of claim 19, where at least one of the first type and second type is one of color flow data, tissue velocity data or data derived from tissue velocity data.

21. The medical ultrasound imaging system of claim 19, where at least one of the first type and second type is B-mode.

22. The medical ultrasound imaging system of claim 19, where at least one of the first and second types is local image gradients.

23. The medical ultrasound imaging system of claim 22, further comprising a light source definition stored in the graphics memory.

24. The medical ultrasound imaging system of claim 16, where the signal processor stores, in the image data block, a first set of vertex entries that define rendering plane definitions and a second set of vertex entries specifies an anatomical model where the signal processor accesses the image data entries and the first set of vertex entries to render the volume according to the plurality of rendering planes with blending shapes for selected image data entries and the second set of vertex entries to render the anatomical model.

25. In a medical ultrasound imaging system, a method for rendering a volume, the method comprising the steps of:
obtaining image components for a volume of a region of interest;
transferring a dataset of image data for the image components into an image data block;
transferring vertex entries for the image components into a vertex data block;
transferring vertex index sets defining rendering planes into a vertex data index; and
initiating volume rendering of the dataset by a graphics processing unit by blending the rendering planes.

26. The method of claim 25, where the step of initiating comprises the step of initiating front to back volume rendering using alpha blending.

27. The method of claim 25, further comprising the step of storing blending parameters in memory for the graphics processing unit.

28. The method of claim 27, where the step of storing blending parameters comprises the step of storing transparency values with the dataset.

29. The method of claim 27, where the step of storing blending parameters comprises the step of storing a transparency lookup table in the memory for the graphics processing unit.

30. The method of claim 25, where the step of transferring vertex entries comprises the step of transferring vertex entries comprising a vertex spatial position and a texture pointer into the dataset.

31. The method of claim 25, where the step of transferring the dataset comprises the steps of:
transferring a first dataset of image data entries for a plurality of ultrasound beams of a first type; and
transferring a second dataset of image data entries for a plurality of ultrasound beams of a second type.

32. The method of claim 31, where the step of transferring vertex entries comprises the step of transferring vertex entries comprising a vertex spatial position, a texture pointer into the first data set, and a texture pointer into the second dataset.

33. The method of claim 31, where at least one of the first type and second type is colorflow.

34. The method of claim 31, where at least one of the first type and second type is B-mode.

35. The method of claim 31, where at least one of the first and second types is local image gradients.

36. The method of claim 25, where the step of transferring the dataset comprises the steps of:
transferring a first dataset of image data entries for a plurality of ultrasound beams of a first type; and
transferring a second dataset of image data entries for an anatomical model.

37. The method of claim 36, where the step of initiating comprises the step of initiating volume rendering of a volume including the anatomical model.

38. The method of claim 37, where the step of initiating comprises the step of initiating alpha blending volume rendering of the volume.
